(19) United States
(12) Patent Application Publication
(10) Pub. No.: US 2016/0335404 A1
(43) Pub. Date: Nov. 17, 2016

(54) SYSTEM AND METHOD FOR PROCESSOR WORKLOAD REDUCTION FOR HEALTHCARE ACTION PLAN

(71) Applicant: MEDECISION, Wayne, PA (US)

(72) Inventors: Srikanth Srinivas, Irving, TX (US); Nicole De Micco, King of Prussia, PA (US)

(21) Appl. No.: 14/709,349

(22) Filed: May 11, 2015

(51) Int. Cl. G06F 19/00; G06F 9/50

(52) U.S. Cl. CPC G06F 19/327; G06F 9/5083

(57) ABSTRACT

A system for reducing processor workload is provided that includes an engagement module operating on the processor and configured to generate one or more profile user interface controls in response to data received from a mapped clinical intelligence rule and to generate user profile data in response to user selection of the profile user interface controls. An assessment module operating on the processor and configured to generate one or more assessment user interface controls in response to data received from the mapped clinical intelligence rule and to generate assessment data in response to user selection of the assessment user interface controls. The mapped clinical intelligence rule includes one or more algorithms for generating a relevancy metric for the one or more profile user interface controls and the one or more assessment user interface controls.

### TECHNICAL FIELD

The present disclosure relates generally to medical analysis and treatment, and more specifically to a care planning tool for medical analysis and treatment that does not require formalistic question and answer processes that can impede patient care and which also significantly increase processor and communications workload.

### BACKGROUND OF THE INVENTION

Automated provision of medical analysis and treatment currently requires a patient or caregiver to fill out extensive question sets, which can delay or prevent automated provision of medical analysis and care management. The amount of processor and communications workload required to complete such extensive question sets is also significant, and typically requires multiple redundant servers to be used to support such activities.

### SUMMARY OF THE INVENTION

A system for reducing processor workload is provided that includes an engagement module that operates on the processor and that generates profile user interface controls in response to data received from a mapped clinical intelligence rule, and user profile data in response to user selection of the profile user interface controls. An assessment module operating on the processor generates assessment user interface controls in response to data received from the mapped clinical intelligence rule, and assessment data in response to user selection of the assessment user interface controls. The mapped clinical intelligence rule includes one or more algorithms for generating a relevancy metric for the profile user interface controls and the assessment user interface controls.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for reducing processor and communications medium loading requirements by providing a care planning tool, in accordance with an exemplary embodiment of the present disclosure;

FIG. 2 is a diagram showing an exemplary relationship between an assessment module and an action plan module, in accordance with an exemplary embodiment of the present disclosure;

FIG. 3 is a diagram of an algorithm for reducing processor and communications system loading in accordance with an exemplary embodiment of the present disclosure; and

FIG. 4 is a diagram of an algorithm of a work flow for reducing processor and communications system loading in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

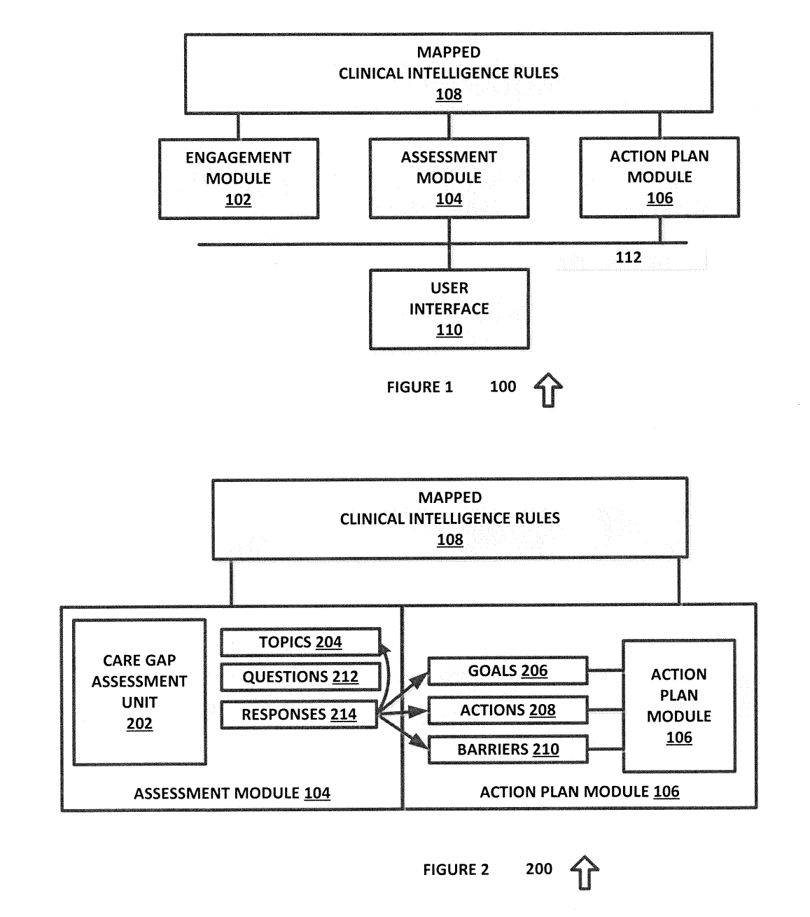

FIG. 1 is a diagram of a system 100 for reducing processor and communications medium loading requirements by providing a care planning tool, in accordance with an exemplary embodiment of the present disclosure. System 100 can be implemented in hardware or a suitable combination of hardware and software, and can be one or more software systems operating on a special purpose processor, and eliminates the amount of redundant or unnecessary processor and communications medium workload required by identifying irrelevant questions for users, by allowing users to skip questions and by identifying action plan contents prior to formal completion of profile questions and other baseline processes.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

System 100 includes engagement module 102, assessment module 104, action plan module 106 and user interface 110. Engagement module 102 generates a user interface to allow a user to provide user profile data, to opt-in or opt-out of disease management, to opt-in or opt-out of case management, that provides notifications or other functions, that identifies other associated health care services providers, that identifies potential products of interest, that identifies government or employer benefits, or that provides other suitable functionality. Engagement module 102 also receives an action plan for an individual and determines further ongoing engagement required under the action plan, such as to prompt a user to complete additional profile information, to take additional actions, to identify potential barriers, to explore additional topics or to take other suitable actions. Unlike prior art intake processes, engagement module 102 allows a user to leave the engagement module and to utilize assessment module 104 or action plan module 106 prior to completing a user profile, as a function of mapped clinical intelligence rules 108.

In one exemplary embodiment, a first mapped clinical intelligence rule can pertain to diabetes, a second mapped clinical intelligence rule can pertain to hypertension, and a third mapped clinical intelligence rule can pertain to heart disease. As a user inputs profile information, the inputted information can be processed by the first, second and third mapped clinical intelligence rules to identify additional topic questions for assessment of diabetes, hypertension and heart disease, and one or more questions can be selected by system 100 for display to the user. In this exemplary embodiment, a score can be generated as a user inputs profile information that indicates the importance of the topic, where additional topics for assessment are scored based on the likely relevance to the entered profile information. For example, if the user's profile information includes a body mass index (BMI) value of greater than 30 and status information for the user of being diabetic, then a topic pertaining to diet and exercise plans can be generated as having a higher relevance than a question pertaining to chest pains. Alternately, if the user's profile information includes a body mass index (EMI) value of greater than 30 and status information for the user of previous reported chest pains, then a question pertaining to whether the user has continued to experience chest pains can be generated as having a higher relevance than a question pertaining to diet and exercise plans. In this manner, the amount of processor time required to obtain relevant care planning tool data can be significantly reduced, through the use of mapped clinical intelligence rules that are configured to allow a user to migrate between an engagement module, an assessment module and an action plan module.

Assessment module 104 receives user profile information and utilizes mapped clinical intelligence rules 108 to generate assessment-related questions. In one exemplary embodiment, the assessment questions can address clinical concerns (such as questions relating to symptoms), behavioral health (such as questions relating to activities and diet), health literacy (such as questions pertaining to knowledge of diagnosed conditions), social support (such as questions relating to assistance provided by friends or family members), transportation needs (such as questions relating to availability of private or public information), mental health status or other suitable assessment questions. Depending on the type of question and entered profile data, system 100 can allow the user to access engagement module 102 from assessment module 104 for entry of additional profile data, then the user can access the other modules at will, such as to go back to assessment module 104 after the completion of the entry of the additional profile data. Likewise, system 100 can allow a user to go from assessment module 104 to action plan module 106, such as by generating a question pertaining to an action plan associated with a health topic, and can then migrate the user back to assessment module 104 upon completion. In each case, a user accesses each separate module independently, such that processor resources required to support an unused module and communications resources to communicate with any unused module are reduced or eliminated.

Action plan module 106 generates one or more action plans for a user in conjunction with mapped clinical intelligence rules 108, profile data from engagement module 102 and assessment data from assessment module 106. In one exemplary embodiment, a single action plan for multiple conditions can be generated. For example, if a patient has diabetes, hypertension, and depression, a single action plan for all three conditions can be generated instead of three separate action plans with redundant or conflicting actions. For example, each action plan can include predetermined segments such as “diet,” “activity” and “medication,” with conflicting actions identified for each, such that predetermined action plans for each condition can be automatically combined, with duplicate actions being eliminated and conflicts being identified for additional assessment.

User interface 110 can be a web browser or other suitable device operating over communications medium 112, which selectively interfaces with engagement module 102, assessment module 104 and action plan module 106. By reducing the amount of time required for each of these modules, system 100 reduces the amount of processor and communications resources required to generate action plans for a user compared to prior art processes that require a user to first complete a user profile entry through a system that performs functions similar to engagement module 102, then to respond to all assessment queries using the same system or a separate system that performs functions similar to assessment module 104, and then to generate one or more separate action plans using the same system or a separate system that performs functions similar to action plan module 106. Such prior art systems lack separate mapped clinical intelligence rules 108 that are mapped to a separate engagement module 102, assessment module 104 and action plan module 106, and combine all functionality into a single system that operates continuously, thus requiring a full processor and communications load in order to support creation of an action plan at all times. For example, if the processor and communications load required to complete the assessment functions is 40 percent, and the processor and communications load required to complete the profile entry functions and the action plan functions is 30 percent, then 100 percent of the processor and communications loading would be required to generate an action plan. In contrast, system 100 provides a flexible workflow that can provide an action plan with significantly reduced processor and communications loading. For example, by allowing a user to skip unimportant questions and to select important questions, the processor and communications load required to move from the profile entry module to the assessment module and the action plan module can be 5 percent or less than the processor and communications load required to fully complete the processes required by all three modules in sequence. In terms of server resources required to support a national deployment, a reduction in server workload of this magnitude could result in a savings of redundant computer servers, and a cost savings in hardware and operations expenses.

Mapped clinical intelligence rules 108 include a plurality of clinical intelligence rules that are mapped to engagement module 102, assessment module 104 and action plan module 106. A mapped clinical intelligence rule can include any suitable rule that embodies clinical intelligence, such as a rule that identifies clinical condition gaps, non-clinical gaps or patient findings such as last mammogram, (from assessment module 104) and which generates outputs that can be used to define an action plan (such as to action plan module 106). The mapped clinical intelligence rules 108 are accessed by each module, and are used to populate data with appropriate modules.

In operation, system 100 allows a user to receive plan of care data while significantly reducing the workload on the processor and communications, by using mapped clinical intelligence rules to allow users to navigate between engagement module 102, assessment module 104 and action plan module 106. In this manner, the need to follow rigid workflow processes can be avoided to allow a user to obtain specific action plan data of interest to the user.

FIG. 2 is a diagram 200 showing an exemplary relationship between assessment module 104 and action plan module 106, in accordance with an exemplary embodiment of the present disclosure. Care gap assessment unit 202 of assessment module 104 receives assessment data from mapped clinical intelligence rules 108 and determines whether a care gap exists based on patient profile data from engagement module 102 and previously-entered assessment data. If it is determined that a care gap exists, additional assessment data is sought, such as by generating additional assessment questions. The assessment data can be obtained using topics 204, questions 212 and responses 214.

Topics 204 allow a user to identify potential topics of interest relative to a patient, such as to allow the user to navigate to topics of potential interest for the patient. In one exemplary embodiment, topics 204 can identify the most statistically relevant topics, can include predetermined topical associations for assessment areas, or can otherwise associate mapped clinical intelligence rules through associated topics for use in an action plan.

Questions 212 are used to obtain specific information of interest from a user, in the form of responses 214. In one exemplary embodiment, each question 212 can have two or more associated predetermined responses 214, where selection of one of the two or more responses 214 can also result in presentation or selection of a new topic 204, identification or selection of a goal 206, an action 208, a barrier 210, a combination of topics 204, goals 206, actions 208 or barriers 210 or other suitable data.

Goals 206 can be provided by mapped clinical intelligence rules, can be associated with topics or actions or can otherwise be identified in a suitable manner that allows them to be provided for use in an action plan. In one exemplary embodiment, goals 206 can include a set of objective accomplishments that are associated with a condition for use in an action plan, such as an amount of activity to be performed, a body mass index or weight level to be obtained, a treatment regimen to be completed or other suitable objectives.

Actions 208 can be provided by mapped clinical intelligence rules, can be associated with topics or goals, or can otherwise be identified in a suitable manner that allows them to be provided for use in an action plan. In one exemplary embodiment, actions 208 can include a set of equivalent activities that can be selected by a user for a patient, such as a set of physical activities (walking, running, cycling, swimming), a set of behavioral activities (watch television no more than one hour a day, get outside one hour a day) or other activities that are associated with a condition for use in an action plan.

Barriers 210 can be provided by mapped clinical intelligence rules, can be associated with the action plan, or can otherwise be identified in a suitable manner that allows them to be provided for use in an action plan. Barriers can be used to identify conditions or other impediments to goals or actions, so as to provide alternative topics, goals or actions for a patient. In one exemplary embodiment, barriers can include a set of common barriers that can be selected by a patient to allow alternative goals, actions or topics to be provided. For example, if a topic has an associated action of physical exercise, then barriers 210 has been identified lacking transportation, the barrier can be used to help identify potential physical exercises at the home, such as alternatives that are available that the barrier does not apply to. In this exemplary embodiment, if a user is not able to walk, that can be selected as a barrier, and alternative forms of exercise can be identified, such as aquatic exercise or physical therapy.

In operation, system 200 allows a care gap to be identified and used to determine topics, actions, goals and barriers for an action plan. System 200 helps to reduce the amount of processor and communications resources that are required to develop an action plan, by eliminating redundant or unnecessary data entry steps and processes.

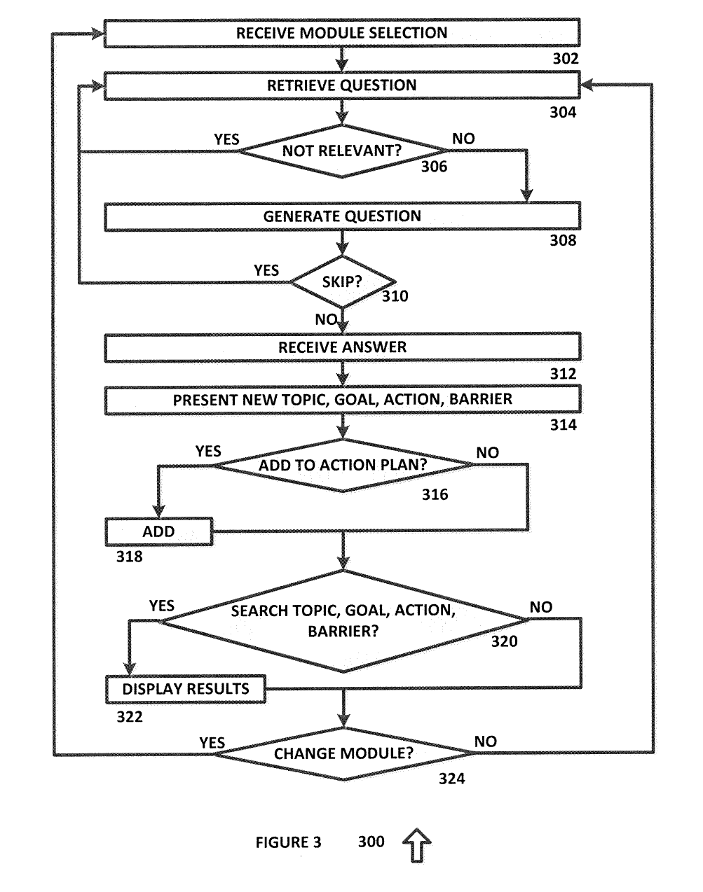

FIG. 3 is a diagram of an algorithm 300 for reducing processor and communications system loading in accordance with an exemplary embodiment of the present disclosure. Algorithm 300 reduces processor and communications system loading by omitting questions that are not relevant from a plan of care process and by providing suggested topics, goals, actions or barriers for an action plan prior to completion of an assessment process.

Algorithm 300 begins at 302, where a module selection is received. In one exemplary embodiment, a user can begin a care planning tool process using an engagement module, can modify a care planning tool through an assessment module, can access an action plan for a care planning tool though an action plan module or can select other suitable modules that support a flexible workflow process that reduces the overall processor and communication workload by allowing a user to develop a patient action plan without the need for filling out irrelevant or unnecessary profile data. The algorithm then proceeds to 304.

At 304, one or more questions associated with a selected module are retrieved. In one exemplary embodiment, the questions can be questions for an engagement module (such as profile entry questions), an assessment module (such as condition status questions), an action plan module (such as to determine progress for an action plan) or other suitable questions. The questions can also or alternatively be provided by a mapped clinical intelligence rules engine that includes clinical intelligence rules that are mapped to the engagement module, the assessment module, the action plan module or other suitable modules. The algorithm then proceeds to 306.

At 306, it is determined whether or not the question is relevant. In one exemplary embodiment, relevance can be determined from the mapped clinical intelligence rules, such as by determining whether one or more parameters of a user profile, prior assessments or an action plan render a particular question irrelevant. If it is determined that the question is not relevant, the algorithm returns to 304 where the next question is retrieved, otherwise the algorithm proceeds to 308.

At 308, the question is generated in a user interface. In one exemplary embodiment, the question can be generated in the form of a user control (proceed?), a user prompt (yes?), multiple user prompts (yes? no?), a form with preselected or user-entered responses, radio buttons, check lists, or in other suitable manners. The algorithm then proceeds to 310.

At 310, it is determined whether the question should be skipped, such as in response to a user-selection of a skip command. Unlike a determination that a question is not relevant, skipping a question does not result from the question being irrelevant, and a user can subsequently be presented with the question, such as in result to subsequent flexible workflow navigation. If the question is skipped at 310, the algorithm returns to 304 where the next question is retrieved, otherwise the algorithm proceeds to 312.

At 312, the answer to the question is received, such as by receiving a user selection, a user data entry or in other suitable manners. The data associated with the answer can be stored in a suitable database associated with a patient or other suitable processes can be used in response to the answer. The algorithm then proceeds to 314.

At 314, a new goal, action, barrier or topic is presented. In one exemplary embodiment, the goal, action, barrier or topic can be presented in response to the answer using mapped clinical intelligence rules or in other suitable manners. The algorithm then proceeds to 316, where it is determined whether to add the goal, action, barrier or topic to an action plan for the patient. In one exemplary embodiment, a care giver or other suitable user can assist a patient in generation of the action plan, in conjunction with the input from the mapped clinical intelligence rules. If it is determined that the goal, action, barrier or topic should be not be added to the action plan, the algorithm proceeds to 320, otherwise the algorithm proceeds to 318, where a database storing the action plan is updated, and the algorithm then proceeds to 320.

At 320, it is determined whether a search for a topic, goal, action or barrier should be performed. In one exemplary embodiment, a user can bypass the suggested topics, goals, actions or barriers generated by the mapped clinical intelligence rules in order to locate other suitable topics, goals, actions or barriers, such as based on the user's experience or knowledge. If it is determined that the user did not perform a search, the algorithm proceeds to 324, otherwise the algorithm proceeds to 322, where the results are displayed. The algorithm then proceeds to 324.

At 324, it is determined whether a module change is required, such as in response to a user selection from the search results. If no module change is required, the algorithm returns to 304, otherwise the algorithm returns to 302, where a module selection is received, such as based on a user selection from the search results.

In operation, algorithm 300 reduces processor and communications workloads for generating an action plan for a patient by using mapped clinical intelligence rules that allow the user to bypass irrelevant or unnecessary questions or topics. Algorithm 300 thus improves the processor and communications efficiency.

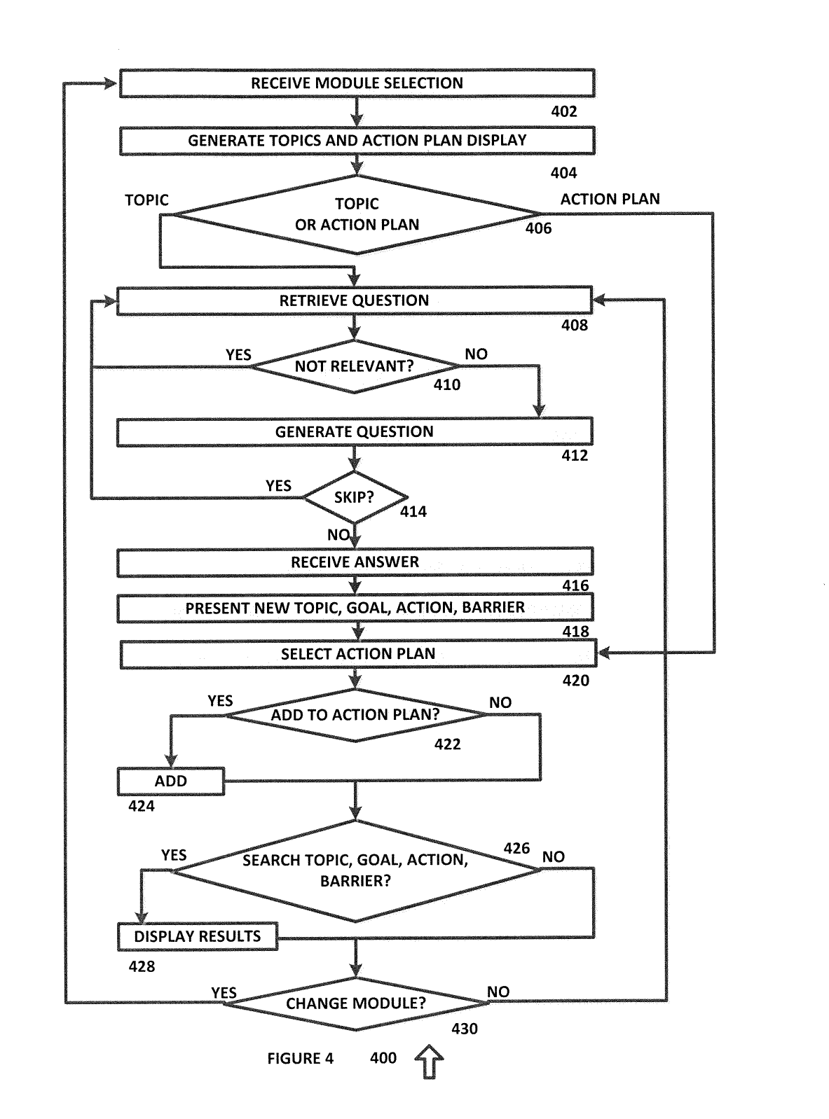

FIG. 4 is a diagram of an algorithm 400 of a work flow for reducing processor and communications system loading in accordance with an exemplary embodiment of the present disclosure. Algorithm 400 reduces processor and communications system loading by omitting questions that are not relevant from a plan of care process and by providing suggested topics, goals, actions or barriers for an action plan prior to completion of an assessment process.

Algorithm 400 begins at 402, where a module selection is received. In one exemplary embodiment, a user can begin a care planning tool process using an engagement module, can modify a care planning tool through an assessment module, can access an action plan for a care planning tool though an action plan module or can select other suitable modules that support a flexible workflow process that reduces the overall processor and communication workload by allowing a user to develop a patient action plan without the need for filling out irrelevant or unnecessary profile data. The algorithm then proceeds to 404.

At 404, topics and action plans are displayed to a user. In one exemplary embodiment, the topics and action plan can be generated in response to patient profile data and mapped clinical intelligence rules, can be based on a patient profile state that identifies patient profile data that has not been entered or addressed or other suitable data. In this regard, it is noted that the patient profile will have associated state data that defines any action items that need to be addressed for the patient. The algorithm then proceeds to 406.

At 406, it is determined whether a selection has been made for a topic or action plan. If it is determined that an action plan has been selected, the algorithm proceeds to 420, otherwise, if a topic has been selected, the algorithm proceeds to 408, where question is retrieved and generated in a user interface. In one exemplary embodiment, the question can be generated in the form of a user control (proceed?), a user prompt (yes?), multiple user prompts (yes? no?), a form with preselected or user-entered responses, radio buttons, check lists, or in other suitable manners. The algorithm then proceeds to 410.

At 410, it is determined whether the question is relevant. If the question is not relevant, the algorithm returns to 408, otherwise the algorithm proceeds to 412, where the question is generated. The algorithm then proceeds to 414, where it is determined whether the question should be skipped. Unlike a determination that a question is not relevant, skipping a question does not result from the question being irrelevant, and a user can subsequently be presented with the question, such as in result to subsequent flexible workflow navigation. If the question is skipped at 414, the algorithm returns to 408 where the next question is retrieved, otherwise the algorithm proceeds to 416.

At 416, the answer to the question is received, such as by receiving a user selection, a user data entry or in other suitable manners. The data associated with the answer can be stored in a suitable database associated with a patient or other suitable processes can be used in response to the answer. The algorithm then proceeds to 418.

At 418, a new goal, action, barrier or topic is presented. In one exemplary embodiment, the goal, action, barrier or topic can be presented in response to the answer using mapped to question response or clinical intelligence rules or in other suitable manners. The algorithm then proceeds to 420, where an action plan for the patient is selected. In one exemplary embodiment, a care giver or other suitable user can assist a patient in generation of the action plan, in conjunction with the input from the mapped clinical intelligence rules. The algorithm then proceeds to 422.

At 422, it is determined whether an addition or modification should be made to the action the action plan. If it is determined that the goal, action, or barrier should be not be added to the action plan, the algorithm proceeds to 426, otherwise the algorithm proceeds to 424, where a database storing the action plan is updated, and the algorithm then proceeds to 426.

At 426, it is determined whether a search for a topic, goal, action or barrier should be performed. In one exemplary embodiment, a user can bypass the suggested topics, goals, actions or barriers generated by the mapped clinical intelligence rules in order to locate other suitable topics, goals, actions or barriers, such as based on the user's experience or knowledge. If it is determined that the user did not perform a search, the algorithm proceeds to 430, otherwise the algorithm proceeds to 428, where the results are displayed. The algorithm then proceeds to 430.

At 430, it is determined whether a module change is required, such as in response to a user selection from the search results. If no module change is required, the algorithm returns to 406, otherwise the algorithm returns to 402, where a module selection is received, such as based on a user selection from the search results.

In operation, algorithm 400 reduces processor and communications workloads for generating an action plan for a patient by using mapped clinical intelligence rules that allow the user to bypass irrelevant or unnecessary questions or topics. Algorithm 400 thus improves the processor and communications efficiency.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for reducing processor workload comprising:
an engagement module operating on the processor and configured to generate one or more profile user interface controls in response to data received from a mapped clinical intelligence rule and to generate user profile data in response to user selection of the profile user interface controls;
an assessment module operating on the processor and configured to generate one or more assessment user interface controls in response to data received from the mapped clinical intelligence rule and to generate assessment data in response to user selection of the assessment user interface controls; and
wherein the mapped clinical intelligence rule includes one or more algorithms for generating a relevancy metric for the one or more profile user interface controls and the one or more assessment user interface controls.

2. The system of claim 1 further comprising an action plan module operating on the processor and configured to generate one or more action plan user interface controls in response to data received from the mapped clinical intelligence rule and to generate action plan data in response to user selection of the action plan user interface controls.

3. The system of claim 2 wherein the mapped clinical intelligence rule includes one or more algorithms for generating a relevancy metric for the one or more action plan user interface controls.

4. The system of claim 1 wherein the assessment module further comprises a response module having a plurality of operative links to a topics module, wherein selection of one of a plurality of responses results in the generation of an associated suggested topic for the selected response.

5. The system of claim 1 wherein the assessment module further comprises a response module having a plurality of operative links to a goals module, wherein selection of one of a plurality of responses results in the generation of an associated goal for the selected response.

6. The system of claim 1 wherein the assessment module further comprises a response module having a plurality of operative links to an actions module, wherein selection of one of a plurality of responses results in the generation of an associated action for the selected response.

7. The system of claim 1 wherein the assessment module further comprises a response module having a plurality of operative links to a barriers module, wherein selection of one of a plurality of responses results in the generation of an associated barrier for the selected response.

8. The system of claim 5 further comprising an action plan module operating on the processor and configured to generate one or more action plan user interface controls in response to data received from the mapped clinical intelligence rule and to generate action plan data in response to user selection of the action plan user interface controls and the associated goal.

9. The system of claim 6 further comprising an action plan module operating on the processor and configured to generate one or more action plan user interface controls in response to data received from the mapped clinical intelligence rule and to generate action plan data in response to user selection of the action plan user interface controls and the associated action.

10. The system of claim 7 further comprising an action plan module operating on the processor and configured to generate one or more action plan user interface controls in response to data received from the mapped clinical intelligence rule and to generate action plan data in response to user selection of the action plan user interface controls and the associated barrier.

11. A method for reducing processor workload comprising:
generating one or more profile user interface controls using a processor in response to data received from a mapped clinical intelligence rule;
generating user profile data in response to user selection of the profile user interface controls;
generating one or more assessment user interface controls in response to data received from the mapped clinical intelligence rule;
generating assessment data in response to user selection of the assessment user interface controls; and
wherein the mapped clinical intelligence rule includes one or more algorithms for generating a relevancy metric for the one or more profile user interface controls and the one or more assessment user interface controls.

12. The method of claim 11 further comprising:
generating one or more action plan user interface controls in response to data received from the mapped clinical intelligence rule; and
generating action plan data in response to user selection of the action plan user interface controls.

13. The method of claim 12 wherein the mapped clinical intelligence rule includes one or more algorithms for generating a relevancy metric for the one or more action plan user interface controls.

14. The method of claim 11 further comprising providing a plurality of operative links to a topics module, wherein selection of one of a plurality of responses results in the generation of an associated suggested topic for the selected response.

15. The method of claim 11 wherein selection of one of a plurality of responses results in the generation of an associated goal for the selected response.

16. The method of claim 11 wherein selection of one of a plurality of responses results in the generation of an associated action for the selected response.

17. The method of claim 11 wherein selection of one of a plurality of responses results in the generation of an associated barrier for the selected response.

18. The method of claim 15 further comprising:
generating one or more action plan user interface controls in response to data received from the mapped clinical intelligence rule; and
generating action plan data in response to user selection of the action plan user interface controls and the associated goal.

19. The method of claim 16 further comprising:
generating one or more action plan user interface controls in response to data received from the mapped clinical intelligence rule; and
generating action plan data in response to user selection of the action plan user interface controls and the associated action.

20. In a system for reducing processor workload comprising an engagement module operating on the processor and configured to generate one or more profile user interface controls in response to data received from a mapped clinical intelligence rule and to generate user profile data in response to user selection of the profile user interface controls, an assessment module operating on the processor and configured to generate one or more assessment user interface controls in response to data received from the mapped clinical intelligence rule and to generate assessment data in response to user selection of the assessment user interface controls, an action plan module operating on the processor and configured to generate one or more action plan user interface controls in response to data received from the mapped clinical intelligence rule and to generate action plan data in response to user selection of the action plan user interface controls, wherein the mapped clinical intelligence rule includes one or more algorithms for generating a relevancy metric for the one or more profile user interface controls and the one or more assessment user interface controls, wherein the mapped clinical intelligence rule includes one or more algorithms for generating a relevancy metric for the one or more action plan user interface controls, wherein the assessment module further comprises a response module having a plurality of operative links to a topics module, wherein selection of one of a plurality of responses results in the generation of an associated suggested topic for the selected response, wherein the assessment module further comprises a response module having a plurality of operative links to a goals module, wherein selection of one of a plurality of responses results in the generation of an associated goal for the selected response, wherein the assessment module further comprises a response module having a plurality of operative links to an actions module, wherein selection of one of a plurality of responses results in the generation of an associated action for the selected response, wherein the assessment module further comprises a response module having a plurality of operative links to a barriers module, wherein selection of one of a plurality of responses results in the generation of an associated barrier for the selected response, an action plan module operating on the processor and configured to generate one or more action plan user interface controls in response to data received from the mapped clinical intelligence rule and to generate action plan data in response to user selection of the action plan user interface controls and the associated goal, the action plan module configured to generate one or more action plan user interface controls in response to data received from the mapped clinical intelligence rule and to generate action plan data in response to user selection of the action plan user interface controls and the associated action, the action plan module configured to generate one or more action plan user interface controls in response to data received from the mapped clinical intelligence rule and to generate action plan data in response to user selection of the action plan user interface controls and the associated barrier, a method comprising:
generating one or more profile user interface controls using a processor in response to data received from a mapped clinical intelligence rule;
generating user profile data in response to user selection of the profile user interface controls;
generating one or more assessment user interface controls in response to data received from the mapped clinical intelligence rule;
generating assessment data in response to user selection of the assessment user interface controls;
generating one or more action plan user interface controls in response to data received from the mapped clinical intelligence rule;
generating action plan data in response to user selection of the action plan user interface controls;
providing a plurality of operative links to a topics module, wherein selection of one of a plurality of responses results in the generation of an associated suggested topic for the selected response;
generating one or more action plan user interface controls in response to data received from the mapped clinical intelligence rule;
generating action plan data in response to user selection of the action plan user interface controls and the associated goal;
generating one or more action plan user interface controls in response to data received from the mapped clinical intelligence rule;
generating action plan data in response to user selection of the action plan user interface controls and the associated action;
wherein the mapped clinical intelligence rule includes one or more algorithms for generating a relevancy metric for the one or more profile user interface controls and the one or more assessment user interface controls;
wherein the mapped clinical intelligence rule includes one or more algorithms for generating a relevancy metric for the one or more action plan user interface controls;
wherein selection of one of a plurality of responses results in the generation of an associated goal for the selected response;
wherein selection of one of a plurality of responses results in the generation of an associated action for the selected response; and
wherein selection of one of a plurality of responses results in the generation of an associated barrier for the selected response.
